(19) United States
(12) Patent Application Publication
(10) Pub. No.: US 2012/0218523 A1
(43) Pub. Date: Aug. 30, 2012

(54) PROJECTION TYPE IMAGE DISPLAY DEVICE

(75) Inventors: Fuminori MIZUNO, Higashiosaka-shi (JP); Naoyuki NIMURA, Higashiosaka-shi (JP); Masutaka INOUE, Hirakata-shi (JP)

(73) Assignee: SANYO ELECTRIC CO., LTD., Moriguchi-shi (JP)

(21) Appl. No.: 13/403,705

(22) Filed: Feb. 23, 2012

(30) Foreign Application Priority Data
Feb. 25, 2011 (JP) 2011-039946

(51) Int. Cl. G03B 21/14

(52) U.S. Cl. 353/69

(57) ABSTRACT

A projecting unit projects a focus adjustment pattern onto a screen. An image capturing unit captures an image of the focus adjustment pattern and obtains the image as a captured image. A captured image analyzing unit calculates contrast data serving as an evaluation value indicating a degree of achievement in focusing the captured image. Based on the calculated contrast data, a control unit adjusts focus of the projecting unit so as to bring projected image light into a focus on the projection surface. The focus adjustment pattern has a first region and a second region different from each other in brightness. The control unit adjusts configurations of the first region and the second region in the focus adjustment pattern such that at least one of resolution of brightness and contrast becomes uniform in the captured image.

This nonprovisional application is based on Japanese Patent Application No. 2011-039946 filed on Feb. 25, 2011 with the Japan Patent Office, the entire contents of which are hereby incorporated by reference.

### BACKGROUND OF THE INVENTION

1. Field of the Invention

The present invention relates to a projection type image display device, more particularly, a projection type image display device having an automatic focus adjustment function of automatically adjusting a focus state of a projected image.

2. Description of the Related Art

A projection type image display device (hereinafter, referred to as “projector”) having an automatic focus adjustment function employs a technique of generating a captured image by capturing an image of a test pattern projected on a projection surface, and adjusting focus thereof using an index value indicating the captured image's focus state, which is varied due to movement of the focal point of image light.

In the projector described above, the test pattern is configured to have white color regions and black color regions arranged alternately in the lateral direction thereof. When an image capturing unit captures an image of the test pattern projected on a screen to generate the captured image, a value indicating a degree of change in brightness in the width direction of the test pattern in the captured image is calculated as an index value indicating a focus state of the captured image.

However, in the above-described conventional technique, there occur a contrast difference and a resolution difference in the captured image due to a positional relation between the image capturing unit and the screen (for example, a distance between the image capturing unit and the screen, an angle of inclination of the image capturing unit relative to the screen, or the like) as well as resolution of the image capturing unit, disadvantageously.

Such contrast and resolution differences in the captured image make it difficult to precisely calculate, from the captured image, the index value indicating the focus state thereof. Accordingly, the focus cannot be adjusted with high precision, disadvantageously.

### SUMMARY OF THE INVENTION

According to an aspect of the present invention, a projection type image display device which projects an image for display includes: a projecting unit which projects a calibration image onto a projection surface; an image capturing unit which captures an image of the calibration image and obtains the image as a captured image; a focusing achievement calculating unit which calculates a degree of achievement in focusing the captured image; and a focus adjusting unit which adjusts focus of the projecting unit based on the calculated degree of achievement in focusing, so as to bring projected image light into a focus on the projection surface. The calibration image has a first region and a second region different from each other in brightness. The projection type image display device further includes a calibration image adjusting unit which adjusts configurations of the first region and the second region such that at least one of resolution of brightness and contrast becomes uniform in the captured image.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic view of a configuration of a projection type image display device according to an embodiment of the present invention.

FIG. 2 is a schematic view of a configuration of an optical engine shown in FIG. 1.

FIG. 3 is a control block diagram of major portions of the projector shown in FIG. 1.

FIG. 4 shows a focus adjustment pattern used as a calibration image in the embodiment.

FIG. 5 is a flowchart illustrating a procedure of an automatic focus adjustment process.

FIG. 6 shows one exemplary captured image generated by an image capturing unit.

FIG. 7 shows one exemplary focus adjustment pattern adjusted through the process of adjusting in the first embodiment of the present invention.

FIG. 8 shows one exemplary captured image generated by the image capturing unit.

FIG. 9 is a flowchart illustrating a procedure of the process of adjusting the focus adjustment pattern in the first embodiment of the present invention.

FIG. 10 shows a contrast difference comparison pattern used as a test image in the embodiment.

FIG. 11 shows one exemplary focus adjustment pattern adjusted by the process of adjusting in a second embodiment of the present invention.

FIG. 12 shows one exemplary captured image generated by the image capturing unit.

FIG. 13 is a flowchart illustrating a procedure of the process of adjusting the focus adjustment pattern in the second embodiment of the present invention.

FIG. 14 shows one exemplary focus adjustment pattern adjusted through the process of adjusting in a third embodiment of the present invention.

FIG. 15 shows one exemplary captured image generated by the image capturing unit.

FIG. 16 is a flowchart illustrating a procedure of the process of adjusting the focus adjustment pattern in the third embodiment of the present invention.

### DESCRIPTION OF THE PREFERRED EMBODIMENTS

The following describes embodiments of the present invention in detail with reference to figures. It should be noted that in the figures, the same or corresponding portions are given the same reference characters and are not described repeatedly.

### First Embodiment

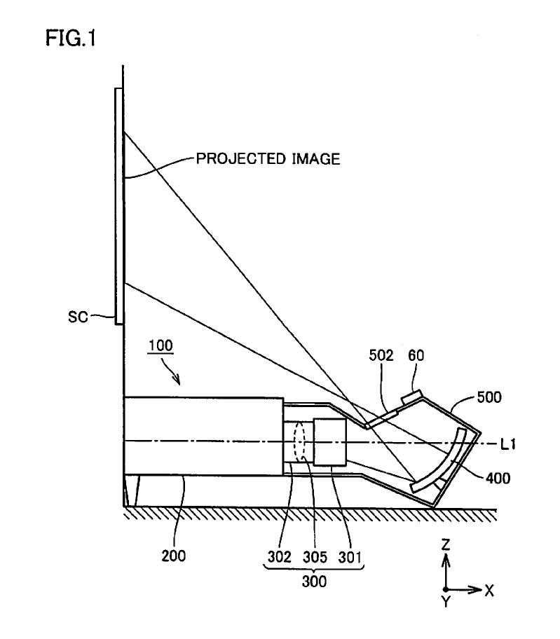

FIG. 1 is a schematic view of a configuration of a projection type image display device according to an embodiment of the present invention.

Referring to FIG. 1, a projection type image display device (hereinafter, referred to as “projector”) 100 includes an optical engine 200, a projection lens unit 300, a reflective minor 400, a cover 500, and an image capturing unit 60. It should be noted that projector 100 also has a component for outputting a sound such as a speaker, a circuit board for electrically controlling a component of optical engine 200 and an audio output unit, and the like, but a part of components including these components are not illustrated in FIG. 1.

Optical engine 200 includes a light source (not shown). Optical engine 200 generates image light by modulating, in accordance with an input image signal, light emitted from the light source. Projection lens unit 300 is attached to optical engine 200. The image light emitted from optical engine 200 enters projection lens unit 300.

Projection lens unit 300 includes an outer casing 301, and an inner casing 302 disposed in outer casing 301. In inner casing 302, a movable lens group 305 is provided. Inner casing 302 is configured to be pivotable in the in-plane direction of the Y-Z plane in the figure. When inner casing 302 is pivoted, the location of movable lens group 305 is displaced in the direction of optical axis L1 by an interlock mechanism such as a cam mechanism. Accordingly, a focus state of a projected image is adjusted. Here, the term “focus state” refers to a state of the focal point of the image light on a certain location. Namely, the location of the focal point of the image light is changed by pivoting inner casing 302 to displace movable lens group 305 back and forth along optical axis L1. By changing the location of the focal point of the image light in this way, the focus state of the projected image is changed.

Reflective mirror 400 is disposed behind projection lens unit 300. Reflective minor 400 has a concave-shaped reflective surface in the form of aspheric surface or free-curved surface, and has an effective reflective region located at a lower side relative to optical axis L1 of projection lens unit 300 (located at a side opposite to a projection opening 502). The image light coming from projection lens unit 300 is reflected by reflective mirror 400.

Projection lens unit 300 and reflective mirror 400 are covered by cover 500. Cover 500 is provided with a projection opening 502, through which the image light reflected by reflective mirror 400 passes.

In this projector 100, when a distance between a screen SC and the main body of the projector is changed to result in change in a projection distance of the image light between projection opening 502 and screen SC, the size of the projected image becomes larger or smaller. Specifically, when an image is intended to be projected in small size, the main body of the projector may be set close to screen SC. On the other hand, when an image is intended to be projected in large size, the main body of the projector may be set distant away from screen SC.

Image capturing unit 60 is disposed on cover 500 in the vicinity of projection opening 502. By disposing image capturing unit 60 as close as possible to projection opening 502 though which the image light passes, the distance (corresponding to the projection distance) from projection opening 502 to screen SC can be detected precisely based on a captured image generated by image capturing unit 60.

Image capturing unit 60 utilizes its image capturing surface to capture an image of a region including the projected image, thereby generating a captured image. Image capturing unit 60 includes: an image capturing element; an image capturing element control unit which controls the image capturing element for, for example, acquisition of an output signal from each pixel of the image capturing element; and an image capturing optical system. An exemplary, usable image capturing element is a CCD (Charge Coupled Device), a CMOS (Complementary Metal-Oxide Semiconductor), or the like. It should be noted that image capturing unit 60 captures the image to sufficiently contain the projected image in the captured image.

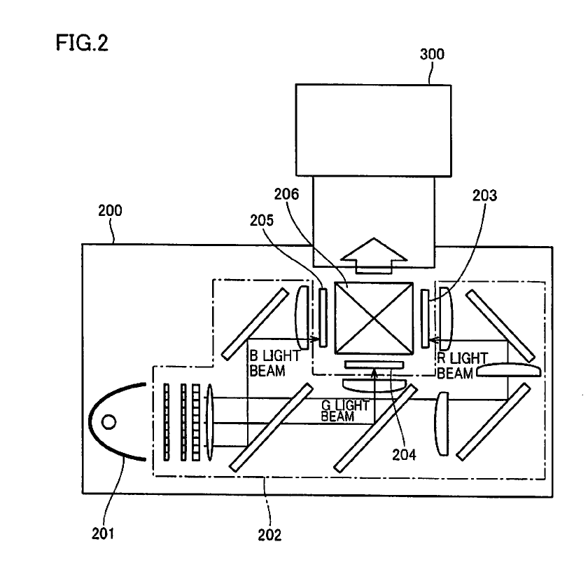

FIG. 2 is a schematic view showing a configuration of optical engine 200 of FIG. 1.

Referring to FIG. 2, optical engine 200 includes a light source 201, a light guide optical system 202, three liquid crystal panels 203, 204, 205 of transmissive type, and a dichroic prism 206. It should be noted that polarizing plates not shown in the figure are provided at the entrance side and exist side of each of liquid crystal panels 203, 204, 205.

Light source 201 emits white light, which is then separated by light guide optical system 202 into a light beam (hereinafter, referred to as “R light beam”) falling within a wavelength range of red, a light beam (hereinafter, referred to as “G light beam”) falling within a wavelength range of green, and a light beam (hereinafter, referred to as “B light beam”) falling within a wavelength range of blue. These light beams are applied to liquid crystal panels 203, 204, 205 respectively. The R light beam, G light beam, and B light beam are respectively modulated by liquid crystal panels 203, 204, 205, then undergo color composite by dichroic prism 206, and then are emitted as the image light.

It should be noted that examples of the light modulating elements of optical engine 200 can include a liquid crystal panel of reflective type and a MEMS device in addition to the above-described liquid crystal panels 203, 204, 205 of transmissive type. In the case where liquid crystal panel(s) are used, an optical system of single plate type employing a color wheel can be used rather than the above-described optical system of three-plate type, for example.

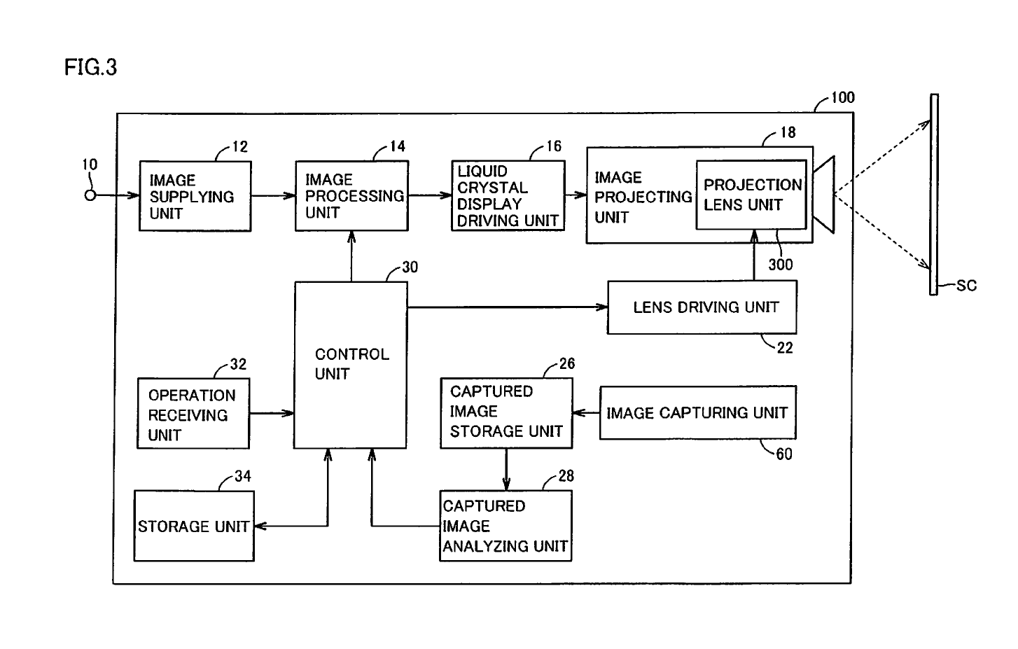

FIG. 3 is a control block diagram showing major portions of projector 100 shown in FIG. 1.

Referring to FIG. 3, projector 100 includes an input unit 10, an image supplying unit 12, an image processing unit 14, a liquid crystal display driving unit 16, an image projecting unit 18, a lens driving unit 22, a control unit 30, an operation receiving unit 32, and a storage unit 34.

Input unit 10 includes an input port for receiving an image signal supplied from an external signal supplying device (not shown). Examples of the signal supplying device include: digital signal supplying devices for outputting digital signals such as a DVD (Digital Versatile Disc) playback device and a Blu-Ray disk playback device; analog signal supplying devices for outputting an analog signal such as a computer; and the like.

Image supplying unit 12 supplies image data to image processing unit 14. Specifically, image supplying unit 12, which is connected to input unit 10, converts an image signal sent from input unit 10 into image data, i.e., a format that can be processed by image processing unit 14, and then sends it to image processing unit 14.

Image processing unit 14 provides various image quality adjustments onto the image data thus supplied from image supplying unit 12, based on instructions from control unit 30. The various image quality adjustments include: resolution conversion of adjusting the resolution thereof to match with the resolution (the number of pixels) of each of liquid crystal panels 203, 204, 205 (FIG. 2); adjustment of luminance; adjustment of contrast; and adjustment of sharpness. Then, image processing unit 14 sends the image signal to liquid crystal display driving unit 16. It should be noted that the image signal sent from image processing unit 14 is constituted by a plurality of pixel values corresponding to all the pixels of liquid crystal panels 203, 204, 205. The term “pixel value” refers to a value defining a light transmittance of a corresponding pixel.

In accordance with the image signal sent from image processing unit 14, liquid crystal display driving unit 16 generates a driving signal for controlling an image display operation of image projecting unit 18 and sends it to image projecting unit 18. Specifically, liquid crystal display driving unit 16 feeds the pixels of liquid crystal panels 203, 204, 205 with driving voltages corresponding to the image signal sent from image processing unit 14, thereby setting the pixels to have light transmittances corresponding to the image signal. In this way, the light emitted from light source 201 (FIG. 2) is modulated by passing through liquid crystal panels 203, 204, 205, thereby forming the color beams of image light each corresponding to the image signal. The formed color beams of image light are combined for each of the pixels by a color composite system, thereby forming the beams into image light representing a color image. Thereafter, the image light representing the color image is projected onto screen SC by projection lens unit 300.

Image projecting unit 18 is configured to include optical engine 200 and projection lens unit 300 shown in FIG. 2. It should be noted that as described above, projection lens unit 300 includes movable lens group 305 (FIG. 1) configured to be displaced along optical axis L1 of projector 100.

Based on an instruction of control unit 30, lens driving unit 22 drives an actuator (including an interlock mechanism such as a cam mechanism) to displace movable lens group 305, which is provided in projection lens unit 300, in the direction of optical axis L1.

It should be noted that movable lens group 305 is configured to be displaced in a certain range in the direction of optical axis L1, and is also configured to be displaced relative to optical axis L1 in a certain range in a direction perpendicular to optical axis L1. In this way, the projection location of the projected image on the projection surface such as screen SC can be adjusted in the vertical and horizontal directions of the screen. By lens driving unit 22 driving the actuator, movable lens group 305 can be displaced.

Control unit 30 includes: a CPU (Central Processing Unit); a ROM (Read Only Memory) constituted by a flash memory or the like; a RAM (Random Access Memory) used for temporary storage of various data; and the like (all of which are not shown in the figures). Control unit 30 functions as a computer. Control unit 30 performs general control over operations of projector 100 by the CPU operating in accordance with a control program stored in storage unit 34. It should be noted that this control program includes an “automatic focus adjustment program”, which serves as a below-described program for automatically adjusting a focus state of the projected image.

Operation receiving unit 32 receives an infrared-modulated remote controller signal from a remote controller operated by a user. The remote controller signal includes a command signal for remotely controlling projector 100.

It should be noted that operation receiving unit 32 receives not only the remote controller signal but also a signal from an operation unit (not shown) provided in the main body of projector 100 and having a plurality of operation buttons for operating projector 100. When the remote controller or the operation unit is operated, operation receiving unit 32 receives the operation and sends a command signal, which triggers various operations of control unit 30.

In the configuration shown in FIG. 3, projector 100 further includes image capturing unit 60, a captured image storage unit 26, and a captured image analyzing unit 28.

Based on an instruction from control unit 30, image capturing unit 60 captures an image of the projected image to generate captured image data. The captured image data thus generated by image capturing unit 60 is then stored in captured image storage unit 26.

Captured image analyzing unit 28 detects the state of the projected image based on the captured image data stored in captured image storage unit 26. Projector 100 according to the present embodiment has an automatic adjustment function of automatically adjusting the projected image based on a result of analysis performed by captured image analyzing unit 28. It should be noted that the state of the projected image includes the below-described focus state, a distortion state of the image, a display size thereof, a display location thereof, and the like. These states of the projected image can be detected based on the projected image that is based on a predetermined calibration image projected on screen SC.

(Automatic Focus Adjustment)

With reference to figures, the following describes the process (hereinafter, referred to as “automatic focus adjustment process”) of automatic focus adjustment performed by projector 100 of the embodiment of the present invention to bring the image light into a focus on the projection surface such as screen SC.

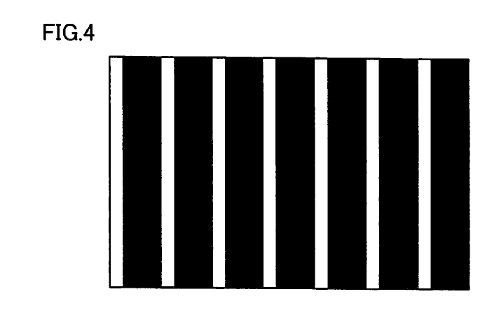

The automatic focus adjustment process is performed by projecting a calibration image onto screen SC. FIG. 4 shows a focus adjustment pattern used as the calibration image in the embodiment of the present invention.

Referring to FIG. 4, the focus adjustment pattern is constituted by two regions different in brightness and arranged alternately in the lateral direction thereof. In FIG. 4, the focus adjustment pattern includes a plurality of black color regions each having a predetermined width, and a plurality of white color regions each having a predetermined width. It should be noted that in the figure, each of the black color regions and each of the white color regions have constant widths respectively, but the width of each of the color regions may differ.

The focus adjustment pattern shown in FIG. 4 is stored in advance in storage unit 34. When the focus automatic adjustment is instructed, control unit 30 reads out the focus adjustment pattern from storage unit 34 and sends it to image processing unit 14. Image processing unit 14 converts the focus adjustment pattern into a signal (display image signal) for display and outputs it. In accordance with the display image signal, liquid crystal display driving unit 16 controls driving of liquid crystal panels 203, 204, 205 provided in image projecting unit 18. In this way, the focus adjustment pattern is projected from projection lens unit 300.

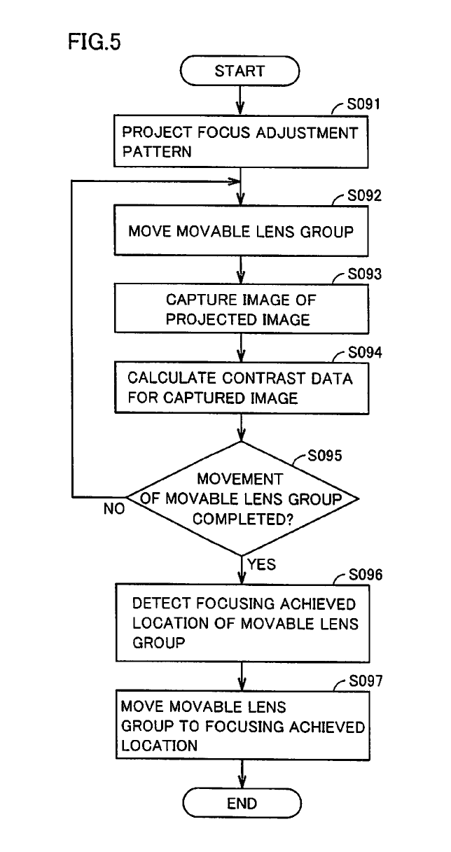

FIG. 5 is a flowchart illustrating a procedure of the automatic focus adjustment process. A process in each of steps shown in FIG. 5 is implemented by the CPU, which constitutes control unit 30, executing the previously stored automatic focus adjustment program in response to the focus adjustment instruction. Alternatively, a part of the processes of the steps can be implemented by dedicated hardware (electronic circuit) constructed.

It should be noted that the focus adjustment instruction corresponds to the command signal issued by operation receiving unit 32 (FIG. 3) when a user operates the remote controller or the operation unit to instruct the automatic focus adjustment. Alternatively, the focus adjustment instruction may be issued when projector 100 is powered on or an image signal is received.

Referring to FIG. 5, in a step S091, control unit 30 instructs image processing unit 14 to project the focus adjustment pattern shown in FIG. 4 onto screen SC.

Next, in a step S092, control unit 30 controls lens driving unit 22 to start moving movable lens group 305 provided in projection lens unit 300. Specifically, lens driving unit 22 supplies a driving signal to the actuator provided in projection lens unit 300. In accordance with the driving signal from lens driving unit 22, the actuator moves movable lens group 305 in the direction of optical axis L1 within its movable range. It should be noted that when the actuator is fed with an advancing direction driving signal from lens driving unit 22, movable lens group 305 is moved in the advancing direction (forward direction), whereas when the actuator is fed with a withdrawal direction driving signal, movable lens group 305 is moved in the withdrawal direction (backward direction). For example, it is assumed that lens driving unit 22 supplies the actuator with the advancing direction driving signal.

In a step S093, control unit 30 causes image capturing unit 60 to capture an image of the focus adjustment pattern projected. The captured image data thus generated by image capturing unit 60 is then stored in captured image storage unit 26.

Then, in a step S094, control unit 30 instructs captured image analyzing unit 28 to analyze the captured image, thereby calculating contrast data serving as an evaluation value indicating a degree of achievement in focusing. When starting to move movable lens group 305 in step S092, control unit 30 starts a timer, generates the contrast data at a certain time interval, and stores it in storage unit 34.

Here, the contrast data is a signal indicating an amount of high frequency component in the signal output by the image capturing element provided in image capturing unit 60. When a larger amount of high frequency component is obtained in the output signal, it is determined that the focus state is such that the focal point of the image light is located closer to screen SC. In other words, when the image light comes into a focus on screen SC (hereinafter, referred to as “focusing achieved state”), a boundary between each white color region and each black color region is expressed distinctively in the focus adjustment pattern projected on screen SC. Accordingly, brightnesses of all the white color regions and black color regions become constant, whereby a value of contrast becomes maximum. On the other hand, when the focal point of the image light is further away from screen SC, white color and black color are expressed to be mixed at the boundary between each white color region and each black color region in the focus adjustment pattern on screen SC. Accordingly, in the vicinity of the boundary, brightness of the black color region becomes large whereas brightness of the white color region becomes small, whereby the value of contrast becomes small.

Thus, there is the following relation of arching curve between the contrast and passage of time from the start of the timer by control unit 30 (the location of movable lens group 305): when movable lens group 305 is moved in a direction in which movable lens group 305 comes closer to a location at which the focus state corresponds to the focusing achieved state, the value of contrast is increased in accordance with the displacement of movable lens group 305; when movable lens group 305 is at the location at which the focus state corresponds to the focusing achieved state, the value of contrast is maximum; and when movable lens group 305 passes through the location at which the focus state corresponds to the focusing achieved state, the value of contrast is reduced. It should be noted that the location of movable lens group 305 at which the focus state corresponds to the focusing achieved state will be also referred to as “focusing achieved location” below.

In a step S095, control unit 30 determines whether or not the movement of movable lens group 305 has been completed by movable lens group 305 reaching a location of the limit value of the predetermined movable range. When movable lens group 305 has not reached the location of the limit value of the movable range (determined NO in step S095), control unit 30 brings the process back to step S092 to continue the movement of movable lens group 305.

On the other hand, when movable lens group 305 has reached the location of the limit value of the movable range (determined YES in step S095), in a step S096, control unit 30 determines the most excellent contrast data (contrast with the maximum value) among those contrast data stored in storage unit 34 and obtains time information (focusing achieved location information of movable lens group 305) at which the most excellent contrast data has been obtained.

Finally, in a step S097, control unit 30 causes movable lens group 305 to be moved to the focusing achieved location. In doing so, control unit 30 instructs lens driving unit 22 to feed the actuator with a withdrawal driving signal for a period of time obtained by subtracting the time indicated by the time information from the period of time during which the actuator has been fed with the advancing direction driving signal. In this way, movable lens group 305 is moved by the actuator to the focusing achieved location.

By performing the above-described processes, projector 100 according to the present embodiment can automatically adjust the focus. It should be noted that in the above-described automatic focus adjustment, the most excellent contrast data is determined after storing in storage unit 34 all the contrast data and time information obtained when moving movable lens group 305 in the predetermined range, but whenever contrast data is obtained at a certain time interval, the contrast data thus obtained may be compared with previous contrast data, and only contrast data having a larger contrast value and corresponding time information may be recorded for updating.

Meanwhile, when there is employed the configuration in which the captured image is generated by capturing the image of the above-described focus adjustment pattern projected on screen SC and the evaluation value (contrast data) regarding a degree of achievement in focusing the captured image is calculated, the automatic focus adjustment may cause a contrast difference and a resolution difference in the captured image due to the positional relation between image capturing unit 60 and screen SC as well as the resolution of image capturing unit 60.

For example, projector 100 in the present embodiment is configured to employ reflective mirror 400 (FIG. 1) to project the image light obliquely in a wide angle so as to attain a short projection distance. In this configuration, image capturing unit 60 is disposed in the vicinity of projection opening 502 through which the image light passes, and captures an image of the focus adjustment pattern (FIG. 4) in the oblique direction. Accordingly, the captured image thus generated by image capturing unit 60 may be provided with a contrast difference and a resolution difference due to the positional relation between image capturing unit 60 and screen SC (the distance between image capturing unit 60 and screen SC or the angle of inclination of image capturing unit 60 relative to screen SC). The contrast difference and the resolution difference in the captured image make it difficult to precisely generate, from the captured image, the contrast data serving as the evaluation value indicating the degree of achievement in focusing.

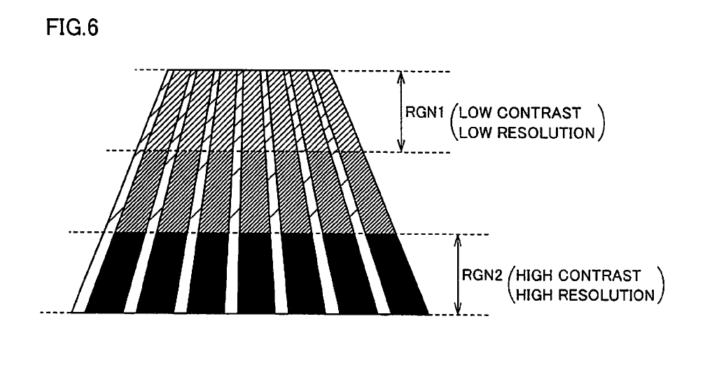

FIG. 6 shows one exemplary captured image generated by image capturing unit 60 when the focus adjustment pattern shown in FIG. 4 is projected.

Referring to FIG. 6, the captured image has a trapezoidal shape having a lower side longer than an upper side thereof. In the captured image having such a trapezoidal shape, the white color regions and the black color regions are arranged alternately in the lateral direction thereof in a reflection of the focus adjustment pattern (FIG. 4). Each of the color regions has a width narrower as it extends upward in the longitudinal direction thereof. This is because image capturing unit 60 is disposed in the vicinity of projection opening 502 in projector 100 according to the present embodiment and therefore obliquely captures the image of the projected image on screen SC.

Further, in the captured image shown in FIG. 6, each of the plurality of white color regions has a difference in brightness in the longitudinal direction thereof. In particular, the brightness is gradually reduced as it extends upward in the longitudinal direction. Likewise, each of the plurality of black color regions also has a difference in brightness in the longitudinal direction thereof. In particular, the brightness is gradually increased as it extends upward in the longitudinal direction. The brightness of each color region is changed because the distance between the image capturing element and screen SC is longer at a higher location in the longitudinal direction. Accordingly, the boundary between each white color region and each black color region is distinctively expressed in a region (region RGN2 in FIG. 6) at the lower side of the captured image, while white color and black color are mixed at the boundary between each white color region and each black color region in a region (region RGN1 in FIG. 6) at the upper side of the captured image. This results in a contrast difference such that the value of contrast becomes larger at region RGN2 of the lower side and the value of contrast becomes smaller at region RGN1 of the upper side in the captured image.

Such a contrast difference in the captured image will provide a small value of contrast in the contrast data obtained from the captured image, even when the image light is almost brought into a focus on screen SC. Thus, the contrast difference in the captured image affects the correlation between the focusing achieved location of movable lens group 305 and the contrast data to make it difficult to precisely adjust the focus.

Further, in the captured image of FIG. 6, the width of each of the white color region and the black color region in region RGN1 of the upper side is narrower than that in region RGN2 of the lower side. Accordingly, depending on the resolution of the image capturing element (a CCD, a CMOS, or the like) of image capturing unit 60, there may occur a difference in resolution of brightness between region RGN2 of the lower side and region RGN1 of the upper side. In the case of FIG. 6, not all the white color regions and black color regions in region RGN1 of the upper side may be resolved. Such a difference in resolution in the captured image makes it impossible to generate precise contrast data, thereby making it difficult to adjust the focus with high precision.

The projector according to the present invention adjusts the focus adjustment pattern so as to compensate the contrast difference and the resolution difference caused in the captured image due to the positional relation between the image capturing unit and the screen, the resolution of the image capturing unit, and the like. Specifically, the focus adjustment pattern is adjusted by adjusting the configuration (shape and brightness) of each of the white color regions and the black color regions arranged alternately. In the first embodiment of the present invention, as one manner of the process of adjusting the focus adjustment pattern, the focus adjustment pattern is adjusted to compensate the contrast difference in the captured image. With reference to figures, the following describes the process of adjusting the focus adjustment pattern in the first embodiment of the present invention.

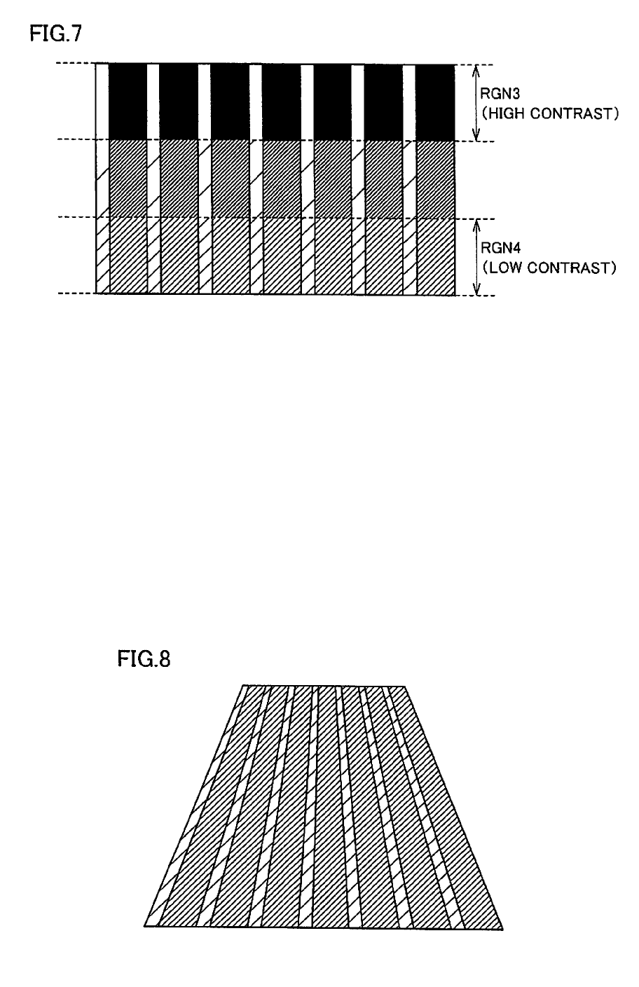

FIG. 7 shows one exemplary focus adjustment pattern adjusted by the process of adjusting in the first embodiment of the present invention.

Referring to FIG. 7, the adjusted focus adjustment pattern is constituted by black color regions and white color regions arranged alternately in the lateral direction as with the focus adjustment pattern shown in FIG. 4. Meanwhile, in the adjusted focus adjustment pattern, each of the color regions is provided with gradation in which the brightness is changed continuously in the longitudinal direction. Specifically, each of the white color regions has a brightness gradually increased as it extends upward in the longitudinal direction. On the other hand, each of the black color regions has a brightness gradually decreased as it extends upward in the longitudinal direction. Accordingly, white color and black color are mixed at a boundary between each white color region and each black color region in a region (region RGN4 in FIG. 7) at the lower side of the captured image, whereas the boundary between the white color region and the black color region is expressed distinctively in a region (region RGN3 in FIG. 7) at the upper side of the captured image.

Here, the gradation in each color region is provided to form, in the focus adjustment pattern, a distribution of contrast opposite to a distribution thereof in the captured image shown in FIG. 6. In other words, in view of the captured image of FIG. 6 having a distribution such that the contrast becomes smaller at a higher location in the longitudinal direction, the focus adjustment pattern of FIG. 7 is provided with a distribution such that the contrast becomes smaller at a lower location in the longitudinal direction. It should be noted that in FIG. 7, each of the black color regions and the white color regions is provided with the gradation, but one of each black color region and each white color region may be provided with such gradation.

FIG. 8 shows one exemplary captured image generated by image capturing unit 60 when the focus adjustment pattern shown in FIG. 7 is projected.

Referring to FIG. 8, the captured image has a trapezoidal shape having a lower side longer than an upper side thereof. In the captured image having such a trapezoidal shape, the white color regions and the black color regions are arranged alternately in the lateral direction in a reflection of the focus adjustment pattern (FIG. 7).

In this captured image, each of the white color regions exhibits a constant brightness. Likewise, each of the black color regions exhibits a constant brightness. Accordingly, contrast in the captured image is uniform. Specifically, the contrast difference in the captured image is canceled by the contrast difference in the focus adjustment pattern by forming, in the focus adjustment pattern, the distribution of contrast opposite to the distribution thereof in the captured image as described above. This results in such uniform contrast in the captured image. Accordingly, from the captured image, contrast data can be generated in a reflection of the correlation with the focusing achieved location of the movable lens group 305, thereby allowing for adjustment of the focus with high precision.

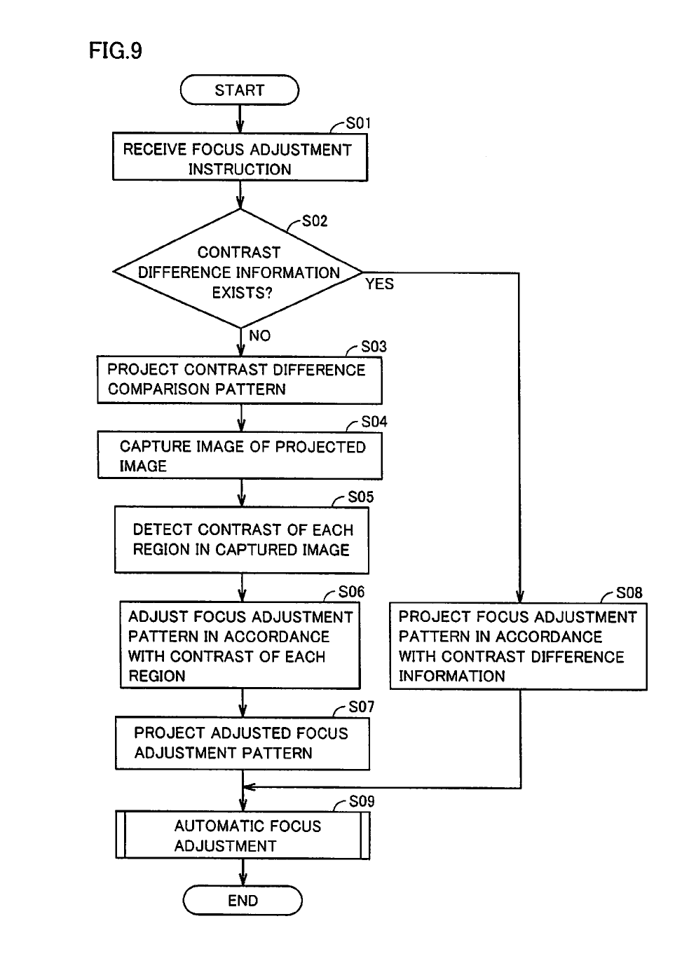

The following describes the process of adjusting the focus adjustment pattern with reference to a flowchart of FIG. 9. It should be noted that a process in each step shown in FIG. 9 is implemented by the CPU, which constitutes control unit 30, executing a previously stored pattern adjusting process program in response to a focus adjustment instruction. Alternatively, a part of the processes of the steps can be implemented by dedicated hardware (electronic circuit) constructed.

Referring to FIG. 9, when a focus adjustment instruction is received in a step S01, control unit 30 determines whether or not storage unit 34 has information (hereinafter, referred to as “contrast difference information”) regarding a contrast difference in a captured image. The contrast difference information is information indicating the contrast difference caused in the captured image due to the positional relation between image capturing unit 60 and screen SC, the resolution of image capturing unit 60, and the like. For example, the contrast difference information can be obtained by previously obtaining a map indicating a corresponding relation between each of the projection distance of projector 100 and the resolution of image capturing unit 60 and the contrast difference in the captured image and by making reference to the map when the projection distance of projector 100 and the resolution of image capturing unit 60 are known. Alternatively, in the case where the main body of the projector is not moved after the previous adjustment of the focus adjustment pattern, contrast difference information obtained in the previous adjustment process can be used.

When storage unit 34 has the contrast difference information (determined YES in a step S02), in a step S08, control unit 30 instructs image processing unit 14 to project the focus adjustment pattern onto screen SC in accordance with the known contrast difference information. It should be noted that based on the known contrast difference information, each color region in the focus adjustment pattern is provided with gradation so as to form, in the focus adjustment pattern, a distribution of contrast opposite to a distribution thereof in the captured image.

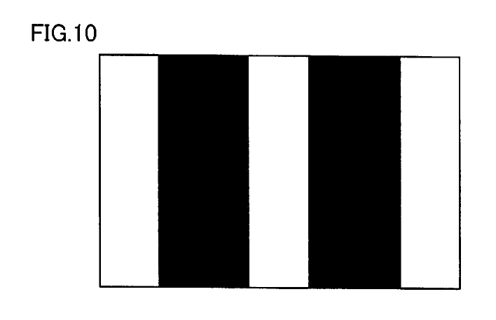

On the other hand, when storage unit 34 does not have the contrast difference information (determined NO in step S02), in steps S03-S05, control unit 30 obtains contrast difference information by performing a process of detecting a contrast difference in the captured image. Specifically, in step S03, control unit 30 instructs image processing unit 14 to project a contrast difference comparison pattern onto screen SC. The contrast difference comparison pattern is a test image used to detect a contrast difference in a captured image, and is constituted by, for example, white color regions and black color regions arranged alternately and having widths wider than those in the focus adjustment pattern as shown in FIG. 10.

In step S04, control unit 30 causes image capturing unit 60 to capture an image of the projected contrast difference comparison pattern. The captured image data thus generated by image capturing unit 60 is then stored in captured image storage unit 26.

Next, in a step S05, control unit 30 instructs captured image analyzing unit 28 to analyze the captured image so as to detect the contrast difference in the captured image. Captured image analyzing unit 28 divides the captured image into a plurality of regions and calculates a contrast for each of the regions. Then, captured image analyzing unit 28 compares the calculated contrasts of the plurality of regions with one another, thereby detecting the contrast difference in the captured image. The detected contrast difference in the captured image is stored in storage unit 34 as contrast difference information.

When the contrast difference information is thus obtained, in a step S06, control unit 30 adjusts the focus adjustment pattern of FIG. 4 in accordance with the contrast difference information. Specifically, control unit 30 instructs image processing unit 14 to provide gradation in each color region of the focus adjustment pattern of FIG. 4 so as to form therein a distribution of contrast opposite to a distribution thereof in the captured image.

Then, in a step S07, control unit 30 instructs image processing unit 14 to project the adjusted focus adjustment pattern onto screen SC. Accordingly, in a step S09, the automatic focus adjustment process (FIG. 5) is performed using the focus adjustment pattern by which the contrast difference in the captured image is compensated.

As described above, according to the projector of the first embodiment of the present invention, the focus adjustment pattern including the white color regions and black color regions each having a brightness adjusted to achieve uniform contrast in the captured image is projected onto the screen when the automatic focus adjustment process is performed. Accordingly, based on the captured image of the focus adjustment pattern, contrast data can be generated in a reflection of the correlation with the focusing achieved location of the movable lens group. As a result, the focus can be adjusted with high precision.

### Second Embodiment

In a second embodiment of the present invention, as another manner of the process of adjusting the focus adjustment pattern in the present invention, the focus adjustment pattern is adjusted to compensate a resolution difference in the captured image. With reference to figures, the following describes the process of adjusting the focus adjustment pattern in the second embodiment of the present invention.

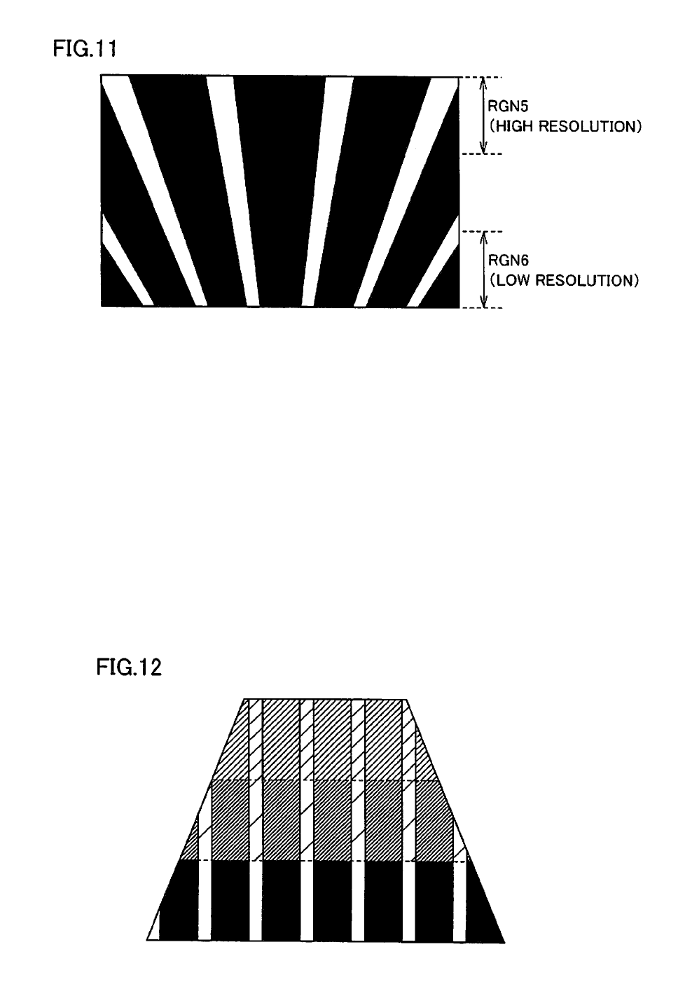

FIG. 11 shows one exemplary focus adjustment pattern adjusted by the process of adjusting in the second embodiment of the present invention.

Referring to FIG. 11, the adjusted focus adjustment pattern is constituted by black color regions and white color regions arranged alternately in the lateral direction as with the focus adjustment pattern shown in FIG. 4. In the adjusted focus adjustment pattern, each of the color regions has a lateral width continuously changing in the longitudinal direction. Specifically, each of the white color regions has a width gradually increased as it extends upward in the longitudinal direction. Likewise, each of the black color regions has a width gradually increased as it extends upward in the longitudinal direction. Accordingly, the number of the white color regions and the number of the black color regions in a region (region RGN5 of FIG. 11) at the upper side are smaller than those in a region (region RGN6 of the FIG. 11) of the lower side in the captured image.

Here, the width of each of the color regions is set in accordance with the positional relation between image capturing unit 60 and screen SC and the resolution of image capturing unit 60 so as to achieve uniform resolution in the captured image. For example, in view of the captured image of FIG. 6 having a resolution smaller at a higher location in the longitudinal direction, the focus adjustment pattern of FIG. 11 is formed such that the widths of the white color regions and the black color regions become wider at a higher location in the longitudinal direction. In other words, in view of the captured image of FIG. 6 having a distribution such that the resolution becomes smaller at a higher location in the longitudinal direction, the focus adjustment pattern of FIG. 11 is provided with a distribution such that the resolution becomes smaller at a lower location in the longitudinal direction.

FIG. 12 shows one exemplary captured image generated by image capturing unit 60 when the focus adjustment pattern shown in FIG. 11 is projected.

Referring to FIG. 12, the captured image has a trapezoidal shape having a lower side longer than an upper side thereof. In the captured image having such a trapezoidal shape, white color regions and black color regions are arranged alternately in the lateral direction in a reflection of the focus adjustment pattern (FIG. 11).

In this captured image, each of the white color regions and the black color regions has a constant width. The resolution difference in the captured image is canceled by the resolution difference in the focus adjustment pattern by forming, in the focus adjustment pattern, the distribution of resolution opposite to the distribution thereof in the captured image as described above. This results in such uniform resolution in the captured image. Accordingly, from the captured image, contrast data can be generated in a reflection of the correlation with the focusing achieved location of the movable lens group 305, thereby allowing for adjustment of the focus with high precision.

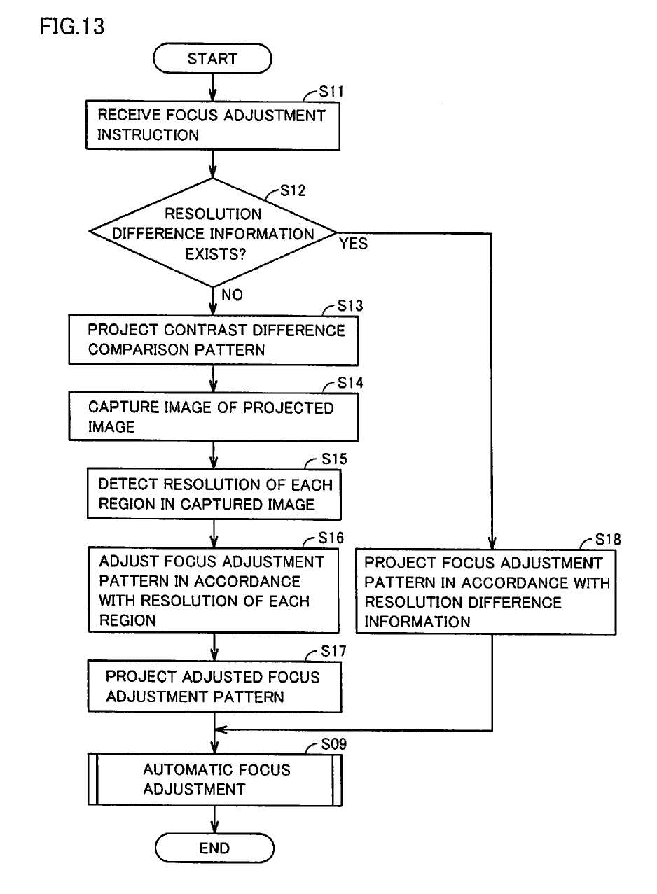

The following describes the process of adjusting the focus adjustment pattern with reference to a flowchart of FIG. 13.

Referring to FIG. 13, when a focus adjustment instruction is received in a step S11, control unit 30 determines whether or not storage unit 34 has information (hereinafter, referred to as “resolution difference information”) regarding a resolution difference in a captured image. The resolution difference information is information indicating the resolution difference caused in the captured image due to the positional relation between image capturing unit 60 and screen SC, the resolution of image capturing unit 60, and the like. For example, the resolution difference information can be obtained by previously obtaining a map indicating a corresponding relation between each of the projection distance of projector 100 and the resolution of image capturing unit 60 and the resolution difference in the captured image and by making reference to the map when the projection distance of projector 100 and the resolution of image capturing unit 60 are known. Further, in the case where the main body of the projector is not moved after the previous adjustment of the focus adjustment pattern, resolution difference information obtained in the previous adjustment process can be used.

When storage unit 34 has the resolution difference information (determined YES in a step S12), in a step S18, control unit 30 instructs image processing unit 14 to project the focus adjustment pattern on screen SC in accordance with the known resolution difference information. It should be noted that based on the known resolution difference information, the width of each color region in the focus adjustment pattern is adjusted to form, in the focus adjustment pattern, a distribution of resolution opposite to a distribution thereof in the captured image.

On the other hand, when storage unit 34 does not have the resolution difference information (determined NO in step S 12), in steps S13-S15, control unit 30 obtains resolution difference information by performing a process of detecting a resolution difference in the captured image. Specifically, in step S13, control unit 30 instructs image processing unit 14 to project a contrast difference comparison pattern (FIG. 10) on screen SC.

In a step S14, control unit 30 causes image capturing unit 60 to capture an image of the projected contrast difference comparison pattern. The captured image data thus generated by image capturing unit 60 is then stored in captured image storage unit 26.

Next, in a step S15, control unit 30 instructs captured image analyzing unit 28 to analyze the captured image so as to detect the resolution difference in the captured image. Captured image analyzing unit 28 divides the captured image into a plurality of regions and calculates a resolution for each of the regions. Then, captured image analyzing unit 28 compares the calculated resolutions of the plurality of regions with one another, thereby detecting the resolution difference in the captured image. The detected resolution difference in the captured image is stored in storage unit 34 as resolution difference information.

When the resolution difference information is thus obtained, in a step S16, control unit 30 adjusts the focus adjustment pattern of FIG. 4 in accordance with the resolution difference information. Specifically, control unit 30 instructs image processing unit 14 to adjust the width of each color region of the focus adjustment pattern of FIG. 4 so as to form therein a distribution of resolution opposite to a distribution thereof in the captured image.

Then, in a step S17, control unit 30 instructs image processing unit 14 to project the adjusted focus adjustment pattern onto screen SC. Accordingly, in a step S09, the automatic focus adjustment process (FIG. 5) is performed using the focus adjustment pattern by which the contrast difference in the captured image is compensated.

As described above, according to the projector of the second embodiment of the present invention, the focus adjustment pattern including the white color regions and black color regions each having a shape adjusted to achieve uniform resolution in the captured image is projected onto the screen when the automatic focus adjustment process is performed. Accordingly, from the captured image, which is generated by the image capturing unit, of the focus adjustment pattern, contrast data can be generated in a reflection of the correlation with the focusing achieved location of the movable lens group. As a result, the focus can be adjusted with high precision.

### Third Embodiment

In a third embodiment of the present invention, as another manner of the process of adjusting the focus adjustment pattern in the present invention, the focus adjustment pattern is adjusted to compensate a contrast difference and a resolution difference in the captured image. With reference to figures, the following describes the process of adjusting the focus adjustment pattern in the third embodiment of the present invention.

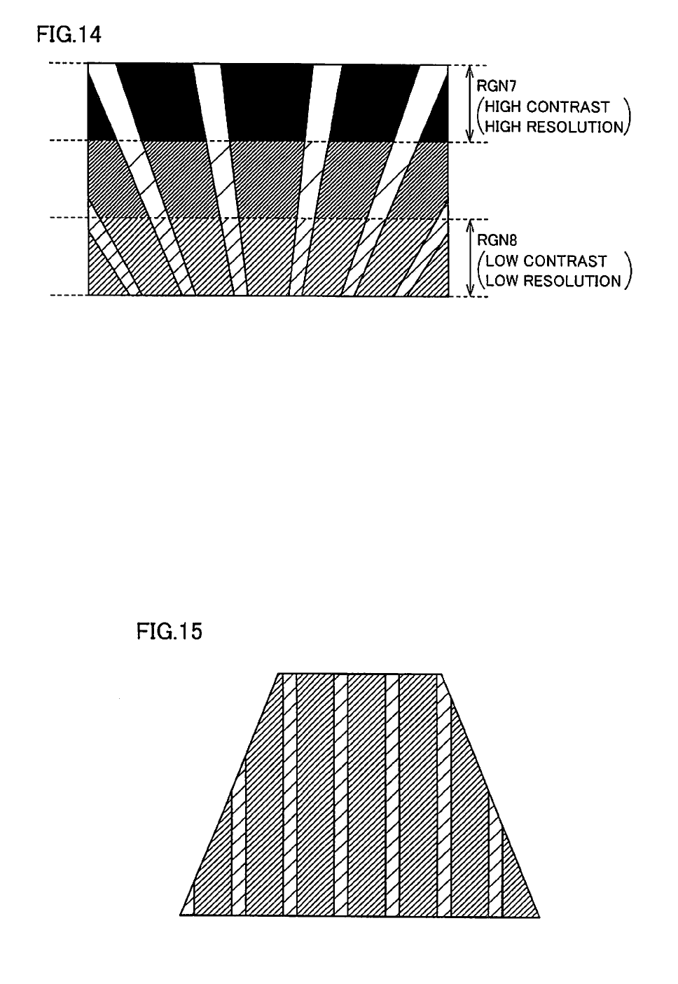

FIG. 14 shows one exemplary focus adjustment pattern adjusted by the process of adjusting in the third embodiment of the present invention.

Referring to FIG. 14, the adjusted focus adjustment pattern is constituted by black color regions and white color regions arranged alternately in the lateral direction as with the focus adjustment pattern shown in FIG. 4. In the adjusted focus adjustment pattern, each of the color regions has gradation in which the brightness is changed continuously in the longitudinal direction. Specifically, each of the white color regions has a brightness gradually increased as it extends upward in the longitudinal direction. On the other hand, each of the black color regions has a brightness gradually decreased as it extends upward in the longitudinal direction. It should be noted that in FIG. 14, each of the black color regions and the white color regions is provided with the gradation, but only one of each black color region and each white color region may be provided with such gradation.

Further, in the adjusted focus adjustment pattern, each of the color regions has a lateral width continuously changing in the longitudinal direction. Specifically, each of the white color regions has a width gradually increased at a higher location in the longitudinal direction. Likewise, each of the black color regions has a width gradually increased at a higher location in the longitudinal direction.

Accordingly, white color and black color are mixed at a boundary between each white color region and each black color region in a region (region RGN8 of FIG. 14) of the lower side in the captured image, whereas the boundary between the white color region and the black color region is expressed distinctively in a region (region RGN7 of FIG. 14) of the upper side in the captured image. Further, the number of the white color regions and the number of the black color regions in region RGN7 at the upper side are smaller than those in the region RGN8 at the lower side in the captured image.

Here, the gradation in each color region is provided to form, in the focus adjustment pattern, a distribution of contrast opposite to a distribution thereof in the captured image shown in FIG. 6. In other words, in view of the captured image of FIG. 6 having a distribution such that the contrast becomes smaller at a higher location in the longitudinal direction, the focus adjustment pattern of FIG. 14 is provided with a distribution such that the contrast becomes smaller at a lower location in the longitudinal direction.

Further, the width of each of the color regions is set in accordance with the positional relation between image capturing unit 60 and screen SC and the resolution of image capturing unit 60 so as to achieve uniform resolution in the captured image. Namely, in view of the captured image of FIG. 6 having the resolution smaller at a higher location in the longitudinal direction, the focus adjustment pattern of FIG. 14 is formed such that the widths of the white color regions and the black color regions become wider at a higher location in the longitudinal direction.

FIG. 15 shows one exemplary captured image generated by image capturing unit 60 when the focus adjustment pattern shown in FIG. 14 is projected.

Referring to FIG. 15, the captured image has a trapezoidal shape having a lower side longer than an upper side thereof. In the captured image having such a trapezoidal shape, white color regions and black color regions are arranged alternately in the lateral direction in a reflection of the focus adjustment pattern (FIG. 14).

In this captured image, each of the white color regions exhibits a constant brightness. Likewise, each of the black color regions exhibits a constant brightness. The contrast difference in the captured image is canceled by the contrast difference in the focus adjustment pattern by forming, in the focus adjustment pattern, the distribution of contrast opposite to the distribution thereof in the captured image. This results in such uniform contrast in the captured image. In this captured image, each of the white color regions and the black color regions has a constant width. The resolution difference in the captured image is canceled by the resolution difference in the focus adjustment pattern by forming, in the focus adjustment pattern, the distribution of resolution opposite to the distribution thereof in the captured image as described above. This results in such uniform resolution in the captured image. As a result, from the captured image, contrast data can be generated in a reflection of the correlation with the focusing achieved location of the movable lens group 305, thereby allowing for adjustment of the focus with high precision.

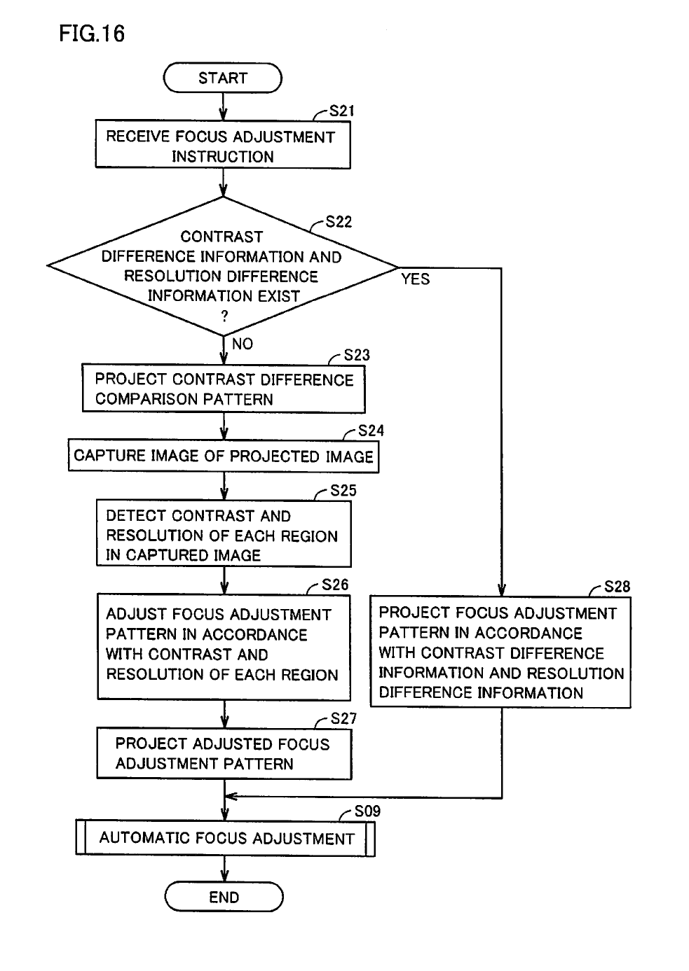

The following describes the process of adjusting the focus adjustment pattern with reference to a flowchart of FIG. 16.

Referring to FIG. 16, when a focus adjustment instruction is received in a step S21, in a step S22, control unit 30 determines whether or not storage unit 34 has contrast difference information and resolution difference information.

When storage unit 34 has the contrast difference information and the resolution difference information (determined YES in step S22), in a step S28, control unit 30 instructs image processing unit 14 to project the focus adjustment pattern onto screen SC in accordance with the known contrast difference information and resolution difference information. It should be noted that based on the known contrast difference information and resolution difference information, the brightness and width of each color region in the focus adjustment pattern are adjusted to form, in the focus adjustment pattern, distributions of contrast and resolution opposite to distributions thereof in the captured image.

On the other hand, when storage unit 34 does not have the contrast difference information and resolution difference information (determined NO in step S22), in steps S23-S25, control unit 30 obtains contrast difference information and resolution difference information by performing a process of detecting a contrast difference and a resolution difference in the captured image. Specifically, in step S23, control unit 30 instructs image processing unit 14 to project a contrast difference comparison pattern (FIG. 10) on screen SC.

In step S24, control unit 30 causes image capturing unit 60 to capture an image of the projected contrast difference comparison pattern. The captured image data thus generated by image capturing unit 60 is then stored in captured image storage unit 26.

Next, in a step S25, control unit 30 instructs captured image analyzing unit 28 to analyze the captured image so as to detect the contrast difference and the resolution difference in the captured image. Captured image analyzing unit 28 divides the captured image into a plurality of regions and calculates a contrast and a resolution for each of the regions. Then, captured image analyzing unit 28 compares the calculated contrasts and resolutions of the plurality of regions with one another, thereby detecting the contrast difference and the resolution difference in the captured image. The detected contrast difference in the captured image is stored in storage unit 34 as contrast difference information. Moreover, the detected resolution difference in the captured image is stored in storage unit 34 as resolution difference information.

When the contrast difference information and the resolution difference information are thus obtained, in a step S26, control unit 30 adjusts the focus adjustment pattern of FIG. 4 in accordance with the contrast difference information and the resolution difference information. Specifically, control unit 30 instructs image processing unit 14 to adjust the brightness and width of each color region of the focus adjustment pattern of FIG. 4 so as to form therein distributions of contrast and resolution opposite to distributions thereof in the captured image.

Then, in a step S27, control unit 30 instructs image processing unit 14 to project the adjusted focus adjustment pattern onto screen SC. Accordingly, in a step S09, the automatic focus adjustment process (FIG. 5) is performed using the focus adjustment pattern by which the contrast difference and the resolution difference in the captured image are compensated.

As described above, according to the projector of the third embodiment of the present invention, the focus adjustment pattern including the white color regions and black color regions each having a shape adjusted to achieve uniform contrast and resolution in the captured image is projected onto the screen when the automatic focus adjustment process is performed. Accordingly, from the captured image, generated by the image capturing unit, of the focus adjustment pattern, contrast data can be generated in a reflection of the correlation with the focusing achieved location of the movable lens group. As a result, the focus can be adjusted with high precision.

It should be noted that as an exemplary configuration of the projector, the first to third embodiments described above illustrate the configuration in which reflective mirror 400 (FIG. 1) is employed to project the image light obliquely in a wide angle so as to attain a short projection distance, but the present invention is not only applicable to such a projector. Specifically, the present invention is applicable to any projector as long as it has a function of generating a captured image by capturing an image of a focus adjustment pattern projected on a screen, and a function of adjusting the focus of the captured image based on an evaluation value regarding a degree of achievement in focusing.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A projection type image display device which projects an image for display, comprising:
a projecting unit which projects a calibration image onto a projection surface;
an image capturing unit which captures an image of said calibration image and obtains the image as a captured image;
a focusing achievement calculating unit which calculates a degree of achievement in focusing said captured image; and
a focus adjusting unit which adjusts focus of said projecting unit based on the calculated degree of achievement in focusing, so as to bring projected image light into a focus on said projection surface,
said calibration image having a first region and a second region different from each other in brightness,
the projection type image display device further comprising a calibration image adjusting unit which adjusts configurations of said first region and said second region such that at least one of resolution of brightness and contrast becomes uniform in said captured image.

2. The projection type image display device according to claim 1, wherein:
said calibration image is constituted by arranging said first region and said second region alternately, and
said calibration image adjusting unit adjusts, in accordance with a positional relation between said image capturing unit and said projection surface as well as resolution of said image capturing unit, respective widths of said first region and said second region in a direction in which said first region and said second region are arranged, so as to achieve uniform resolution of brightness in said captured image.

3. The projection type image display device according to claim 2, wherein said calibration image adjusting unit adjusts each of the widths of said first region and said second region in the direction in which said first region and said second region are arranged, such that each of the regions has a constant width in said captured image.

4. The projection type image display device according to claim 1, wherein said calibration image adjusting unit adjusts, in accordance with a positional relation between said image capturing unit and said projection surface as well as resolution of said image capturing unit, at least one of the brightness of said first region and the brightness of said second region so as to achieve uniform contrast in said captured image.

5. The projection type image display device according to claim 4, wherein said calibration image adjusting unit provides at least one of said first region and said second region with gradation in which the brightness is continuously changed, so as to exhibit a constant brightness in each of the regions within said captured image.

6. The projection type image display device according to claim 1, wherein:
said projecting unit projects, onto said projection surface, a test image constituted by said first and second regions each having a predetermined width and arranged alternately, and
said image capturing unit captures an image of said test image projected by said projecting unit and obtains the image as a captured image,
the projection type image display device further comprising a detecting unit which detects a contrast difference and a resolution difference in said captured image based on said captured image, wherein
said calibration image adjusting unit adjusts the configurations of said first region and said second region based on a result of the detection performed by said detecting unit.
